(19) United States
(12) Patent Application Publication
(10) Pub. No.: US 2016/0371762 A1
(43) Pub. Date: Dec. 22, 2016

(54) SYSTEM AND METHOD FOR PROVIDING ENERGY-EFFICIENT PRODUCT RECOMMENDATIONS CONSISTENT WITH DEFINED ECONOMIC CRITERIA

(71) Applicant: Renovate America, Inc., San Diego, CA (US)

(72) Inventors: Nicholas William Fergis, Cortez, CO (US); John Paul McNeill, San Diego, CA (US)

(21) Appl. No.: 15/040,955

(22) Filed: Feb. 10, 2016

Related U.S. Application Data
(63) Continuation of application No. 13/528,547, filed on Jun. 20, 2012, now abandoned.
(60) Provisional application No. 61/499,093, filed on Jun. 20, 2011.

(51) Int. Cl. G06Q 30/06; G06Q 50/06

(52) U.S. Cl. CPC G06Q 30/0631; G06Q 50/06

(57) ABSTRACT

Systems and methods in accordance with the disclosure provide product recommendations and other information for a conventional home-based energy monitoring system. An exemplary system in accordance with the disclosure is adapted to exchange information with a conventional home energy monitoring system to collect electricity information from electrical equipment within a residential or other building. Data relating to electricity usage information of appliances and other electrical equipment in a monitored site is collected by the monitoring system and provided to an Internet-based server on a regular basis. Product recommendation algorithms executing on the server utilize this data together with information relating to individual electrical appliances and equipment, rebate and incentive information and user-defined or default investment priorities or other economic criteria, to generate recommendations for replacement of the electrical appliance/equipment currently in use at the monitored premises.

### PRIORITY

This application is a continuation of U.S. patent application Ser. No. 13/528,547, entitled “SYSTEM AND METHOD FOR PROVIDING ENERGY-EFFICIENT PRODUCT RECOMMENDATIONS CONSISTENT WITH DEFINED ECONOMIC CRITERIA,” filed on Jun. 20, 2012, which claims priority to U.S. Provisional Application No. 61/499,093 entitled “SYSTEM AND METHOD FOR PROVIDING ENERGY-EFFICIENT PRODUCT RECOMMENDATIONS CONSISTENT WITH DEFINED ECONOMIC CRITERIA,” filed on Jun. 20, 2011, the contents of each of which are hereby expressly incorporated by reference in their entirety for all purposes.

### FIELD

The present disclosure relates generally to energy management systems and, more particularly, to a system and method for providing recommendations and other information relating energy-efficient products used within, for example, residential or small office environments.

### BACKGROUND

The energy consumed by the appliances and other electrical and electronic equipment in residential or small office buildings is generally monitored by standard electric meters. Such meters furnish information relating to the overall use of energy within the building over a particular period of time. However, such standard meters do not provide information concerning energy use during specific time intervals, nor do these meters enable monitoring of the energy individually consumed by the various electrical devices within such buildings.

More recently, “smart meters” capable of providing substantially real-time readings of electricity usage have been deployed. In addition, home energy monitoring systems have been introduced which enable energy usage to be monitored on a room-by-room basis through a user interface presented by a conventional personal computer. Such systems may utilize current pricing information provided by electric utilities and provide various recommendations concerning ways in which a building owner may reduce electric bills.

Finally, at least one proposed energy management system is described as being capable of calculating, based on equipment information on electrical equipment which is used by a resident, a power consumption estimated when a replacement is made with energy-saving equipment. The system is also described as enabling display of the estimated power consumption and the power consumption of the electrical equipment owned by a building resident in order to allow the resident to become aware of how the replacement may help save energy.

### SUMMARY

Exemplary embodiments of the invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

An exemplary method for energy management in accordance with the disclosure includes receiving, from an energy monitoring system in communication with an energy-consuming product, energy usage information relating to the energy-consuming product, and determining, based upon at least the energy usage information, an estimated energy usage. The method further includes receiving, via a network interface, product data relating to alternate energy-consuming products, storing the product data within a memory, determining, based upon at least the estimated energy usage, cost information relating to the energy-consuming product and to a category of the alternate energy-consuming products, and generating, based upon at least the cost information and the product data, a recommendation to replace the energy-consuming product with at least one of the alternate energy-consuming products.

Another exemplary method for energy management in accordance with the disclosure includes receiving, from an energy monitoring system in communication with an energy-consuming product, energy usage information relating to the energy-consuming product, and determining, based upon at least the energy usage information, an estimated energy usage. The method further includes receiving, via a network interface, product data relating to at least one alternate energy-consuming product wherein the product data includes purchase incentive information, storing the product data within a memory, determining, based upon at least the estimated energy usage, cost information relating to the energy-consuming product and to the at least one alternate energy-consuming product, and generating, based upon at least the cost information and the product data, a recommendation to replace the energy-consuming product with the at least one alternate energy-consuming product.

Yet another method for energy management in accordance with the disclosure includes receiving, from an energy monitoring system in communication with an energy-consuming product, energy usage information relating to an energy-consuming product, and receiving, via a network interface, alternate product data relating to alternate energy-consuming products, the alternate product data including purchase incentive information. The method further includes storing the product data within a memory, determining, based upon at least the energy usage information, cost information relating to the energy-consuming product and to a category of the alternate energy-consuming products, receiving information relating to a user-defined financial objective, and generating, based upon the cost information and the user-defined financial objective, a recommendation to replace the energy-consuming product with at least one of the alternate energy-consuming products.

A system for energy management in accordance with the disclosure includes one or more network interfaces configured to receive, from an energy monitoring system in communication with an energy-consuming product, energy usage information relating to the energy-consuming product, and receive product data relating to alternate energy-consuming products. The system further includes a processor communicatively coupled to the one or more network interfaces and configured to determine, based upon at least the energy usage information, an estimated energy usage, store the product data within a memory, determine, based upon at least the estimated energy usage, cost information relating to the energy-consuming product and to a category of the alternate energy-consuming products, and generate, based upon at least the cost information and the product data, a recommendation to replace the energy-consuming product with at least one of the alternate energy-consuming products.

Another system for energy management in accordance with the disclosure includes one or more network interfaces configured to receive, from an energy monitoring system in communication with an energy-consuming product, energy usage information relating to the energy-consuming product, and receive product data relating to at least one alternate energy-consuming product wherein the product data includes purchase incentive information. The system further includes a processor communicatively coupled to the one or more network interfaces and configured to determine, based upon at least the energy usage information, an estimated energy usage, store the product data within a memory, determine, based upon at least the estimated energy usage, cost information relating to the energy-consuming product and to the at least one alternate energy-consuming product, and generate, based upon at least the cost information and the product data, a recommendation to replace the energy-consuming product with the at least one alternate energy-consuming product.

Yet another system for energy management in accordance with the disclosure includes one or more network interfaces configured to receive, from an energy monitoring system in communication with an energy-consuming product, energy usage information relating to an energy-consuming product, receive alternate product data relating to alternate energy-consuming products, the alternate product data including purchase incentive information, and receive information relating to a user-defined financial objective The system further includes a processor communicatively coupled to the one or more network interfaces and configured to store the product data within a memory, determine, based upon at least the energy usage information, cost information relating to the energy-consuming product and to a category of the alternate energy-consuming products, and generate, based upon the cost information and the user-defined financial objective, a recommendation to replace the energy-consuming product with at least one of the alternate energy-consuming products.

### BRIEF DESCRIPTION OF THE DRAWINGS

The present invention is more fully appreciated in connection with the following detailed description taken in conjunction with the accompanying drawings, wherein:

FIG. 1 illustrates various components of an exemplary embodiment of the HECTR system described herein;

FIG. 2 provides a high-level representation of the operation of a Product Aggregation Engine included within a network server of the HECTR system;

FIG. 3 provides a high-level representation of the operation of an Incentive Aggregation Engine included within the network server;

FIG. 4 illustrates the loading of property and component data provided by a home monitoring application into tables maintained by the network server;

FIG. 5 illustratively represents processing steps carried by an exemplary recommendation method executed within the network server;

FIG. 6 provides a high-level representation of an exemplary method of building alternative component and product sets by property.

FIG. 7 provides a high-level representation of an exemplary method for forecasting costed usage.

FIG. 8 provides a high-level representation of an exemplary method for building alternative data usage sets.

FIG. 9 illustratively represents an exemplary product recommendation engine configured to perform a two-phase recommendation method.

FIG. 10 provides a high-level representation of a process of determining various saving amounts and other information based upon component usage data.

FIG. 11 illustratively represents a process of determining various measures of financial performance based upon information included within an alternate product analysis table.

FIG. 12A shows an example of Old Product Table D104 containing Non Energy Efficient product data.

FIG. 12B shows an example of Product Table D101 containing Energy Efficient Product data.

FIG. 12C shows an example of a Utility Company Component Incentive Table listing components by zip code for which a Utility Company has offered incentives to homeowners to purchase.

FIG. 12D shows an example of a Manufacturer Rebates Table D202 that identifies a list of products and their manufacturers for which the manufacturer is offering a rebate amount for a specified date range in a specified product region.

FIG. 12E shows an example of a Property Table D301, maintaining records of identifiers for a specific property.

FIG. 12F shows an example of a Property Component Table D302 listing component information for components associated with a property.

FIG. 12G shows an example of an Interface Usage Table D040.

FIG. 12H shows an example of a first Usage Table D401 listing hourly usage data for a property_component for a month.

FIG. 12I shows an example of a second Usage Table D401 listing one record for the 1^{st} hour of every day for 15 days.

FIG. 12J shows an example of a third Usage Table D401 listing forecasted usage data determined from a costing process in accordance with the disclosure.

FIG. 12K shows an example of a PAC (Property Alternative Component) View Table PV1 listing current estimated levels of excess consumption for property components.

FIG. 12L shows an example of an Alternate Component Usage Table D402 showing costs for alternate components for a year.

FIG. 12M shows an example of a Component Analysis Table D403 in accordance with the disclosure.

FIG. 12N shows an example of a Product Analysis Table D404 in accordance with the disclosure.

### DETAILED DESCRIPTION

Embodiments of a Home Energy Cost Reducer “HECTR” system designed to enable a homeowner or other building owner to decide when to invest in and install or otherwise implement energy-saving equipment, infrastructure or methods for the purpose of reducing energy consumption are described herein.

In one embodiment the HECTR system includes a component executed by an Internet-based server in communication with a conventional home energy monitoring system, such as the PC-based system provided by, for example, EcoDog, Inc. In certain embodiments the HECTR system could be utilized to provide product recommendations and other information to such a conventional home-based energy monitoring system. In other implementations the HECTR system could provide such recommendations to a building owner directly through a dedicated PC-based client or browser interface utilizing electricity usage information provided by the conventional home monitoring system. Other embodiments in which the HECTR system is adapted to exchange information with a conventional home energy monitoring system are within the scope of the present disclosure, as are embodiments in which the HECTR system itself employs known techniques to collect electricity information from electrical equipment within a residential or other building.

During operation of the HECTR system, data relating to electricity usage information of appliances and other electrical equipment in a monitored premises is collected by the local monitoring system and generally provided to the Internet-based server on a regular basis (e.g., daily). As described herein, product recommendation algorithms executing on the server may utilize this data together with information relating to individual electrical appliances and equipment, rebate and incentive information, and user-defined or default investment priorities or other economic criteria in order to generate recommendations for replacement of the electrical appliance/equipment currently in use at the monitored premises Such recommendations may enable energy consumers and property owners to replace relatively inefficient electrical equipment/appliances with more efficient products in a manner that optimizes defined economic priorities or criteria (e.g., return on investment, or investment amount).

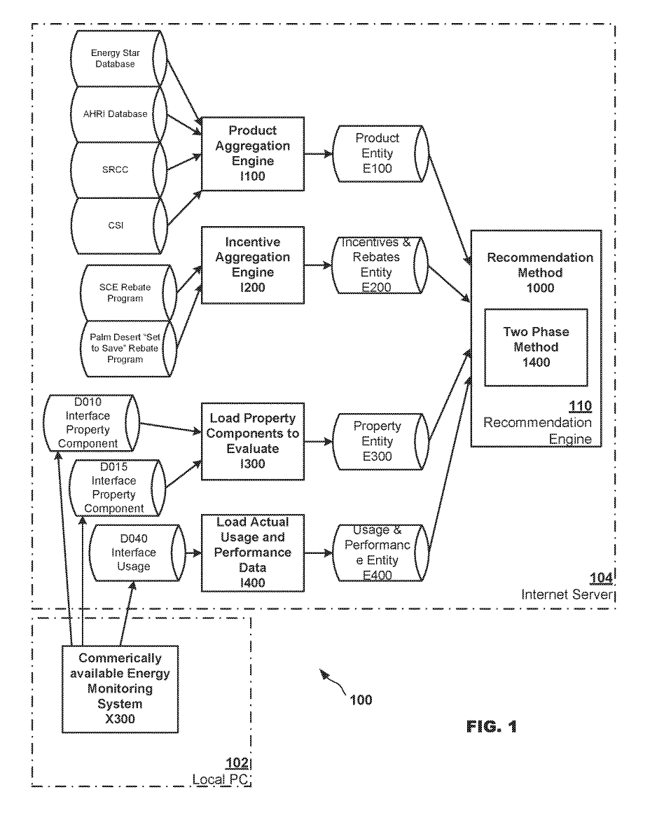

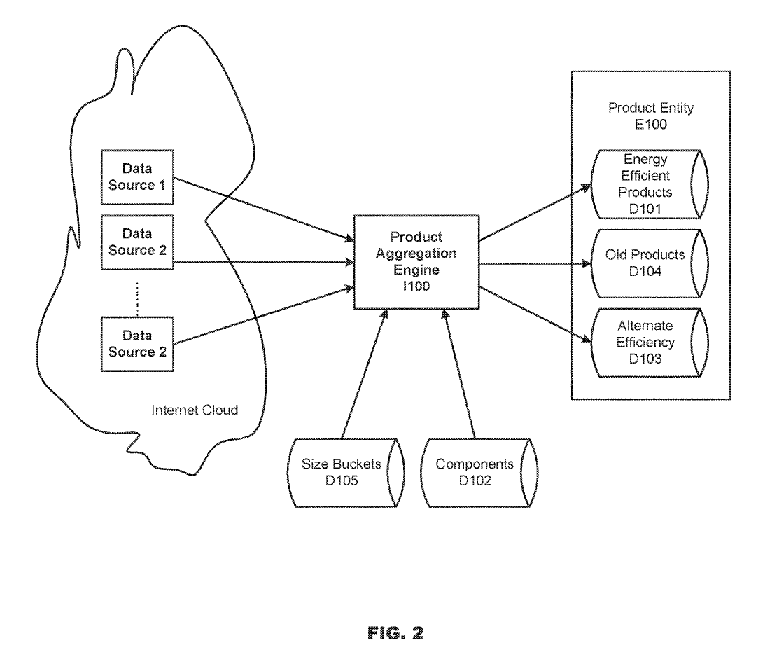

In reference to FIG. 1 and in further reference to FIGS. 2-11, in an exemplary embodiment, the HECTR system 100 operates to receive actual home energy usage data from a commercially available energy monitoring system X300, running on the homeowner's local PC 102, in two forms: periodic buckets of Actual Electricity Usage D401 for each of the desired energy consuming products, “Property Components,” D302 in a home, and as Performance Alerts D405 which identify Property Component performance degradation impacting the Property Component's Energy consumption by a quantified or quantifiable amount. In this embodiment other data utilized in connection with operation of the system 100 is either stored in association with, or accessed through, an Internet-based server 104.

In the exemplary embodiment, the HECTR system 100 includes a Product Aggregation Engine I100 which aggregates both Energy Efficient Product Data D101 and Non Energy Efficient Product Data D104 from a multitude of disparate data sources accessible via the Internet. The Data D101 and the Data D104 may be pulled from, for example, the Web sites of appliance manufacturers, rating services, and consumer product information services or entities and stored within a database or memory associated with Internet-based server 104.

The HECTR system 100 may also include an Incentive Aggregation Engine I200 which functions to aggregate related Manufacturer Product Rebates D202 and Utility Company Incentives D201 by product and/or by region, and apply such incentives to calculate the Net Cost of potential replacement products in an Alternate Product Analaysis Table D404.

In one embodiment the HECTR system 100 enables User Defined Investment Priorities D506 such that the home owner can define potentially competing priorities such as “Investment Amount”, “Targeted Return on Investment”, “Targeted Reduction in Energy Consumption,” etc.

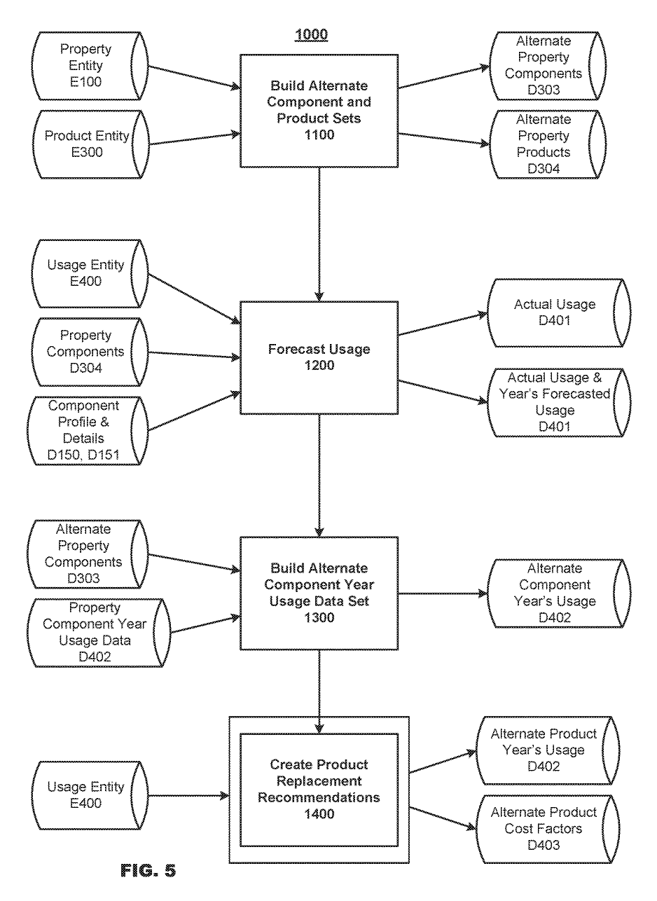

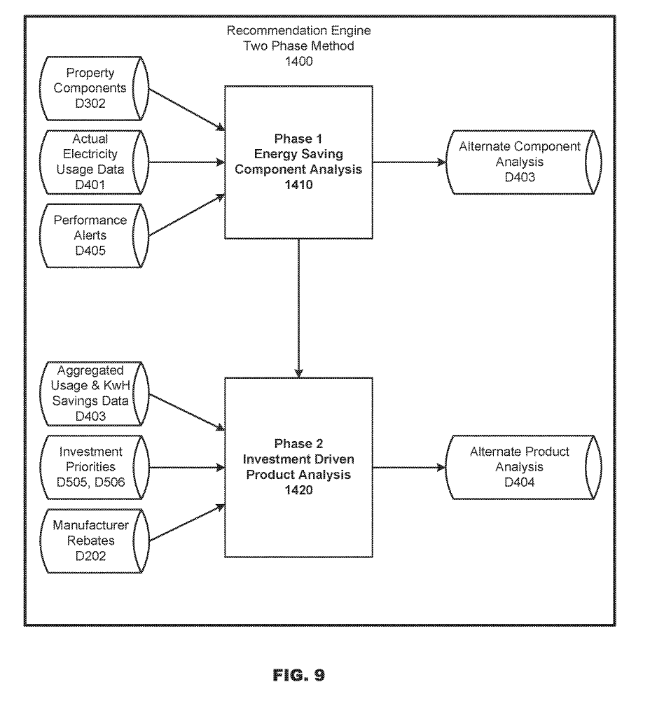

In an exemplary aspect, the HECTR system 100 applies, on a daily basis, a “Method” 1000 (FIGS. 5-8) to: evaluate all Incentive and rebate information, and user investment priority input data; accurately forecast a year of usage, given a partial year of actual usage for each Property Component of interest; and through including another method, the “Two Phase Method” 1400 (FIGS. 9-11), perform optimal energy saving recommendations to reduce electricity consumption in a manner consistent with the home owners investment priorities.

In an exemplary embodiment Phase One 1410 (see FIG. 9) of the Two Phase Method 1400 performs energy savings calculations for Property Components based on relative efficiencies of categories of products, where these categories of products are defined by their size and efficiency rating attributes. Phase Two 1420 (see FIG. 9) of the Two Phase Method 1400, employs user defined investment priorities and applies investment related energy savings calculations to the net costs of the multitude of potential alterative products. The Two Phase Method 1400 results in a cohesive set of energy saving component and product recommendations geared specifically to the home owner's interests.

The HECTR system 100 may also recommend qualified contractors to perform installation service.

Set forth below is a detailed description of an exemplary embodiment of the HECTR system, which is organized as follows:

I. A first section describes the operation of the Product Aggregation Engine I100 and the Incentive Aggregation Engine I200 in collecting product-related and incentive-related information and in populating tables and other data structures accessible to the Internet-based server 104 using this collected information.

II. A second section describes the loading of a Property Component Data Engine I300 representative of the electrical appliances and infrastructure in use at the premises being monitored. In one embodiment this property component data is furnished by a conventional PC-based home monitoring software program X300 operative at the premises being monitored.

III. A third section describes the operation of a Load Actual Usage and Performance Data Engine I400 in collecting usage and performance data from the monitored premises and populating tables and other data structures accessible to the Internet-based server 104 using this collected information.

IV. A fourth section describes the Product Recommendation Method 1000 and, in particular, a Two-Phase Method 1400 which may be utilized in connection with generating economically efficient product recommendations consistent with defined user priorities or criteria.

Load Data from External Sources

Referring to FIG. 1, the HECTR system 100 has data gathering routines including: Product Aggregation Engine I100 which aggregates energy efficient products on the market “Energy Efficient Products”, and most non-energy efficient products “Old Products”, from a variety of disparate data sources in the cloud; Incentive Aggregation Engine I200 which aggregates location and Component specific utility company incentives, and product specific manufacturer rebates, “Incentives,” also from a variety of disparate data sources in the cloud; and, Property Component Evaluation Engine I300 which gets data from the PC based energy monitoring hardware and software system X300 located in customer's homes;

Product Aggregation Engine I100

Attention is now directed to FIG. 2, which provides a high-level representation of the operation of the Product Aggregation Engine I100.

Energy Efficient and Non-Energy Efficient Products

Product Aggregation Engine I100 periodically populates a Product Table D101, an Old Product Table D104 and an Alternate Efficiency Table D103. These tables D101, D103 and D104 are logically grouped into Product Entity E100 seen in FIG. 2, and are physically located in the Database of Record RA_DB01.

Product Aggregation Engine I100 uses the following tables as input:

Component Table D102

Each record in Component Table D102 below is referred to as a “Component” and represents either: 1. a direct energy consuming product type such as HVAC, Refrigerator, Dishwasher, Clothes Washer, Dryer, Pool Pump, etc., or 2. an envelope level improvement opportunity such as Ceiling or Wall Insulation or 3: an indirect energy consumer such as Windows.

Component Table D102 is setup data, keyed in manually in advance of the system being deployed, and represents the list of standard widely known product types “Components” such as “HVAC” (heating, ventilation and air conditioning) and “FAU” (forced air unit), and would hence be a superset of the Components found in any given home. The exact names used to identify this data may be decided upon by the administrator of the system. They need only to “make sense” to the user, see Table D102 below:

Component Table D102

| | | | | | comp_ | comp_ |
|---|---|---|---|---|---|---|
| | | ee_ | | load_ | action_ | profile_ |
| comp_id | Name | uom | size_uom | type | default | id |
| 1 | HVAC | SEER | BTU | HVAC | Recommend | 1 |
| 2 | FAU | EF | PCT | FAU | Monitor | 0 |

Size Bucket Table D105

The data in Size Bucket Table D105 below is derived in advance of the system being deployed by reviewing the product data collected thru the Product Aggregation Engine I100, whereby the user may, at their choosing, define buckets of size ranges that are associated with products of each particular type. Size Bucket Table D105 data is entered manually by the user, see below:

Size_Bucket Table D105

| size_id | comp_id | start_bucket | end_bucket |
|---|---|---|---|
| 50 | 1 (HVAC) | 62500 | 65000 |
| 51 | 1 (HVAC) | 65001 | 67500 |
| 52 | 1 (HVAC) | 67501 | 70000 |

The Product Aggregation Engine I100 can continuously monitor many disparate cloud based databases and data sources, e.g., 40 or more, to collect information on over 50,000 energy efficient products and 100,000 non-energy efficient products.

Product Aggregation Engine I100 classifies products as either “Non Energy Efficient” or “Energy Efficient” according to industry accepted classification standards published by, for example, Energy Star and/or the DOE. Product Aggregation Engine I100 applies values stored in the energy efficiency attributes of the data sources for each product such as SEER (seasonal energy efficiency ratio in BTU) for HVAC, Energy Factor (EF in percentages, PCT) and EE (energy efficiency) for Refrigerators, to standard values of Energy Efficient equipment belonging to the respective product types, suggested by the DOE and Energy Star which determine if a particular product meets Energy Efficient Thresholds.

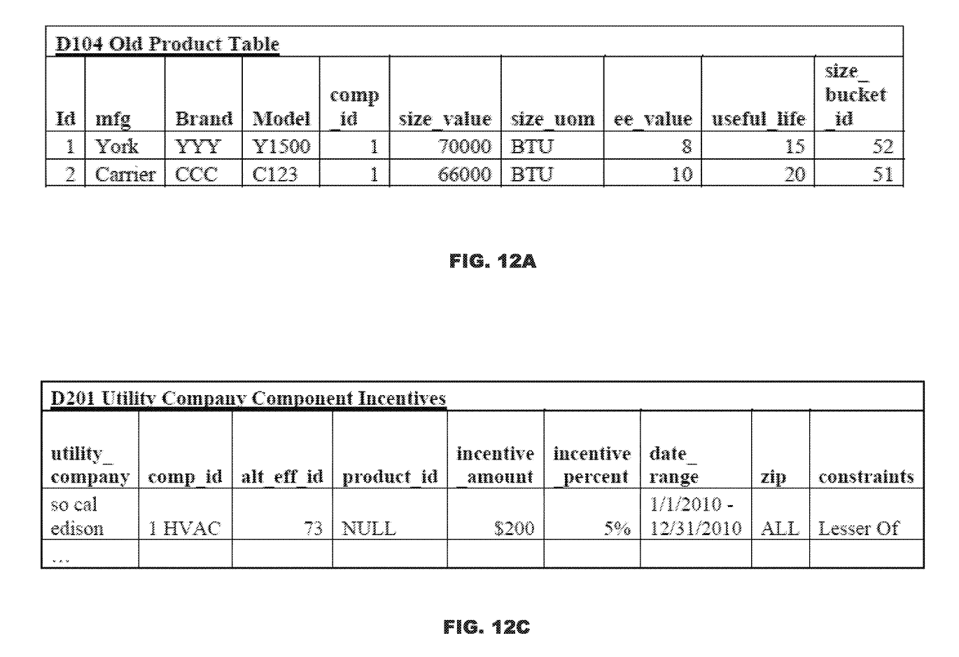

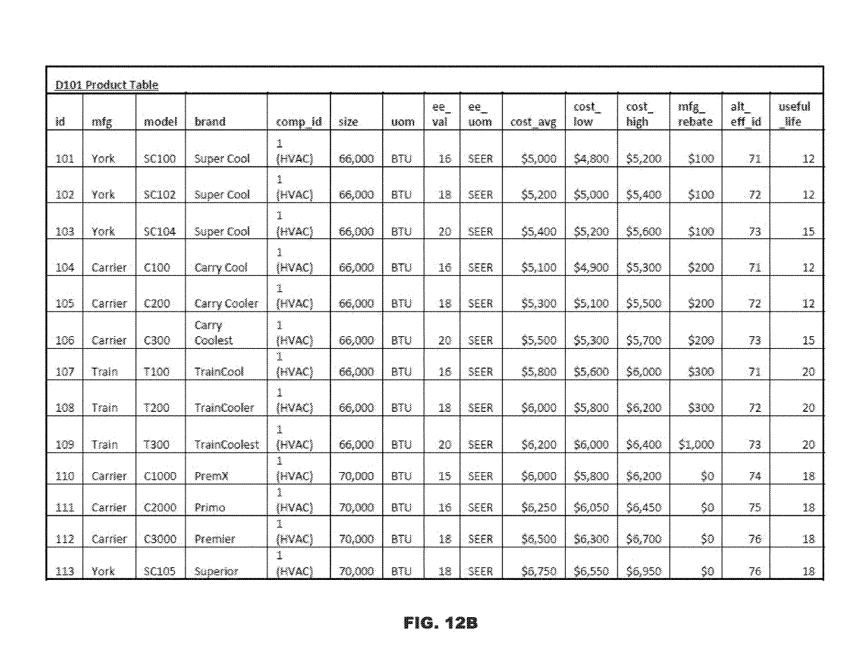

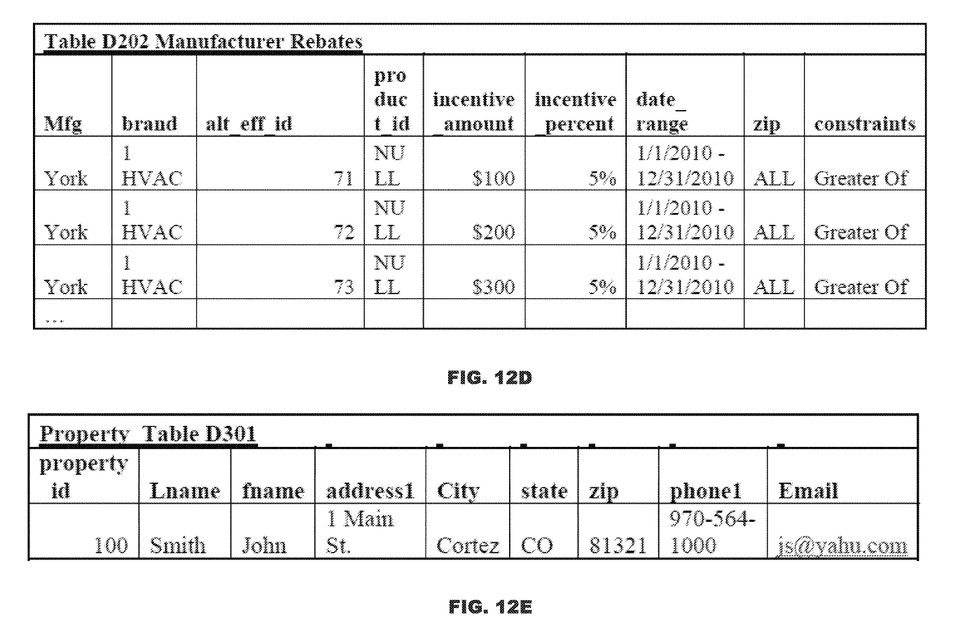

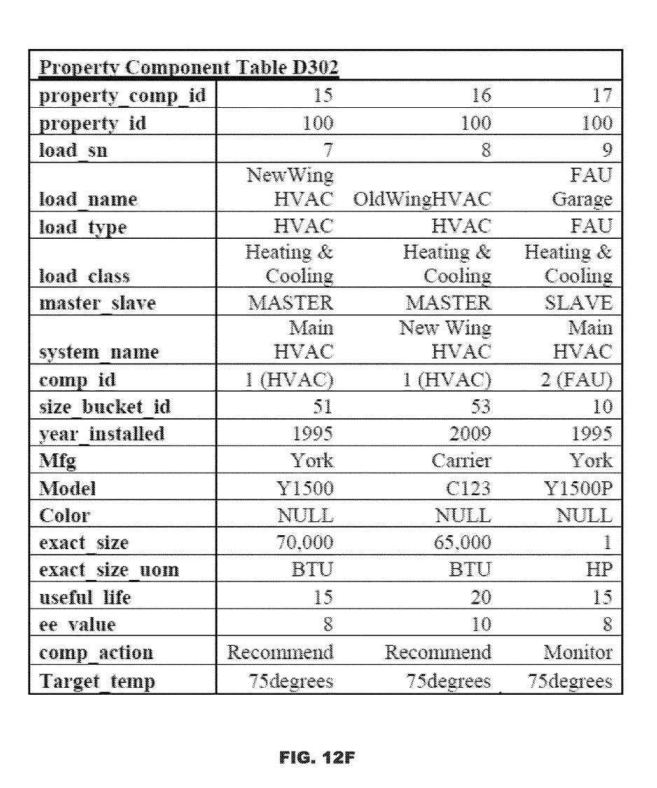

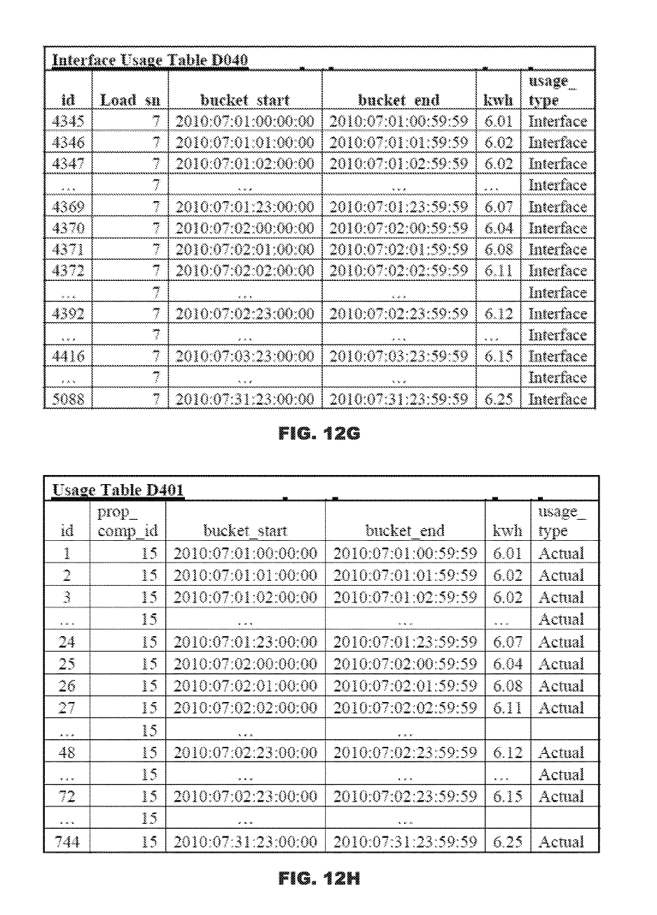

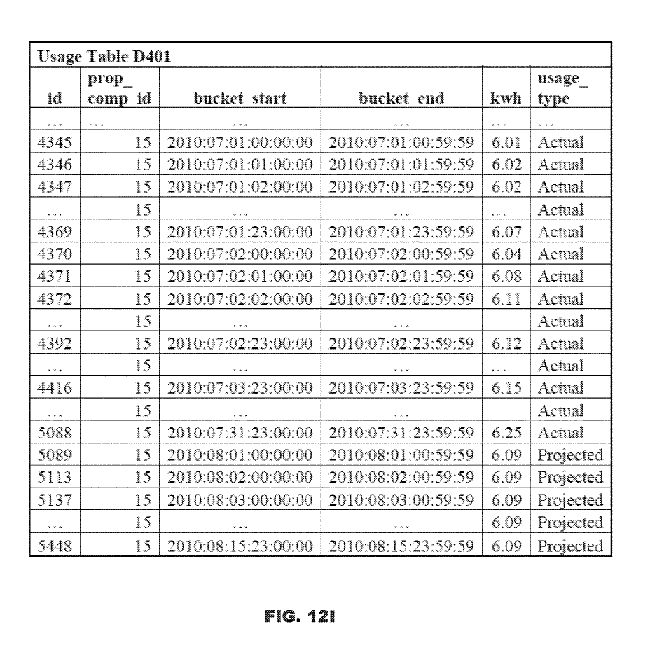

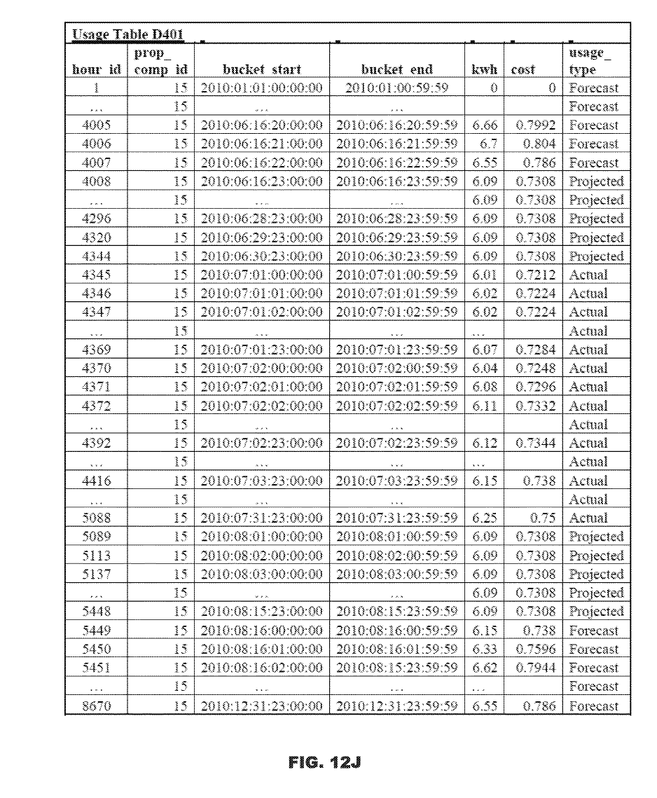

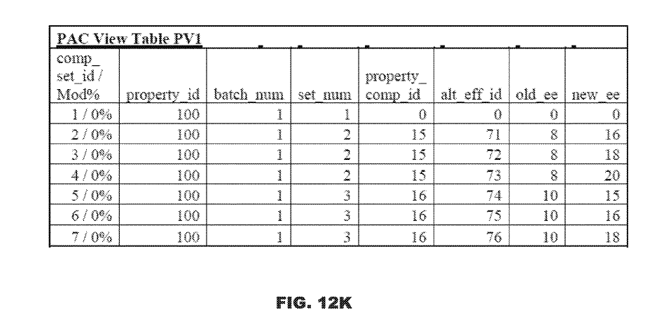

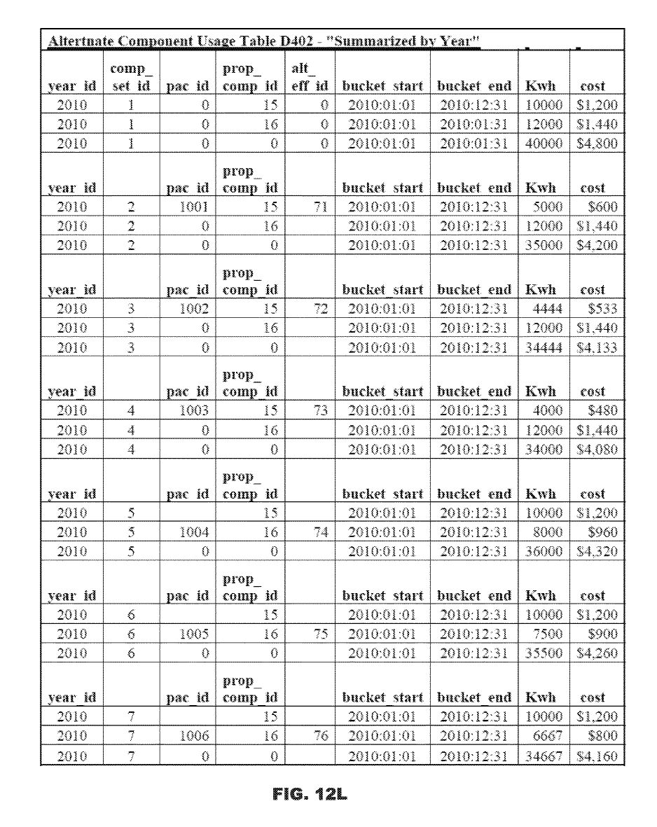

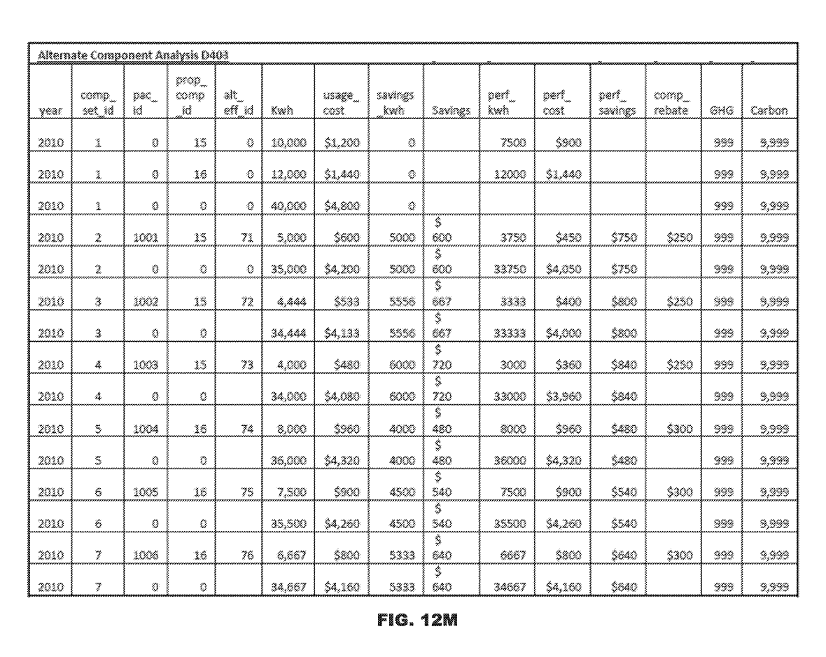

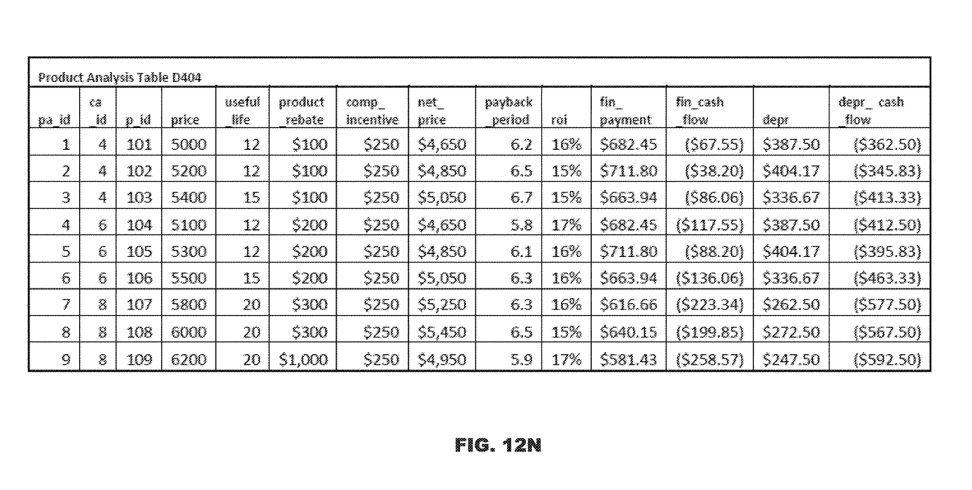

Referring to FIG. 12A, the Product Aggregation Engine I100 loads Non Energy Efficient product data in an Old Product Table D104.

Product Aggregation Engine I100 assigns the comp_id for each record in the Old Product Table D104. A comp_id is assigned when the Product Aggregation Engine I100 is launched based on the data source as each component has its own data source. Many records in Table D104 can reference a single Table D102 record as Table D102 represents a Component or type of product, and the each record in Table D104 represents specific products. Table D102 is joined to Table D104 by the foreign key reference between D104.comp_id and D102.comp_id. Note: The format “D 102.comp_id” refers to the “comp_id” field in Table “D102 ”.

Product Aggregation Engine I100 assigns the size_bucket_id to a each record in Table D104 by identifying the Size_Bucket_Table D105.size_id where D104.comp_id=D105.comp_id and

Product Aggregation Engine I100 Loads Energy Efficient Product data into the Product Table D101, see FIG. 12B.

Product Aggregation Engine I100 assigns the comp_id for each record in Product Table D101. Many Table D101 records can reference a single D102 record, joined by the foreign key reference between D101.comp_id and D102.comp_id.

Product Aggregation Engine I100 assigns the size_bucket_id to a each record in Table D101 by looking up the Size_Bucket_Table D105.size_id where D101.comp_id=D105.comp_id and D101.size_value is between D105.start_bucket and D105.end_bucket.

Product Aggregation Engine I100 populates records in Alternate Efficiency Table D103 below by executing the code exemplified by the following pseudo SQL statement: “SELECT UNIQUE comp_id, size_bucket_id, ee_value from Product INTO Alt_Efficiency.”

Alternate Efficiency Table D103

| alt_ | size_ | start_ | end_ | | ee_ | comp_ |
|---|---|---|---|---|---|---|
| eff_id | bucket_id | size | size | ee_uom | value | id |
| 0 | 0 | 0 | 0 | Na | 0 | 0 |
| 71 | 51 | 65001 | 67500 | SEER | 16 | 1 |
| 72 | 51 | 65001 | 67500 | SEER | 18 | 1 |
| 73 | 51 | 65001 | 67500 | SEER | 20 | 1 |
| 74 | 52 | 67501 | 70000 | SEER | 15 | 1 |
| 75 | 52 | 67501 | 70000 | SEER | 16 | 1 |
| 76 | 52 | 67501 | 70000 | SEER | 18 | 1 |

The Alternate Efficiency Table D103 enables the grouping of products, into their defining energy efficiency attributes and their size buckets, such that products of the same size_bucket_id may be considered valid alternate products. Due to the sheer volume of data processing, the algorithm can be implemented by costing out the usage of such alternative groupings of products, in order to cut trillions of CPU cycles out of the otherwise intensive computations required to evaluate, cost, and forecast usage of all individual products. In this manner, usage costing and analysis may be performed at the “Component's” Alt_Efficiency_ID level rather than at the detailed product level.

Product Aggregation Engine I100 updates the records in Table D101 with D103.alt_eff_id identified by joining D101.comp_id to D103.comp_id, and D101.size_bucket_num to D103.size_bucket_num, and D101.ee_value to D103.ee_value.

I200 Aggregate Utility Company Component Incentives and Manufacturer Rebates

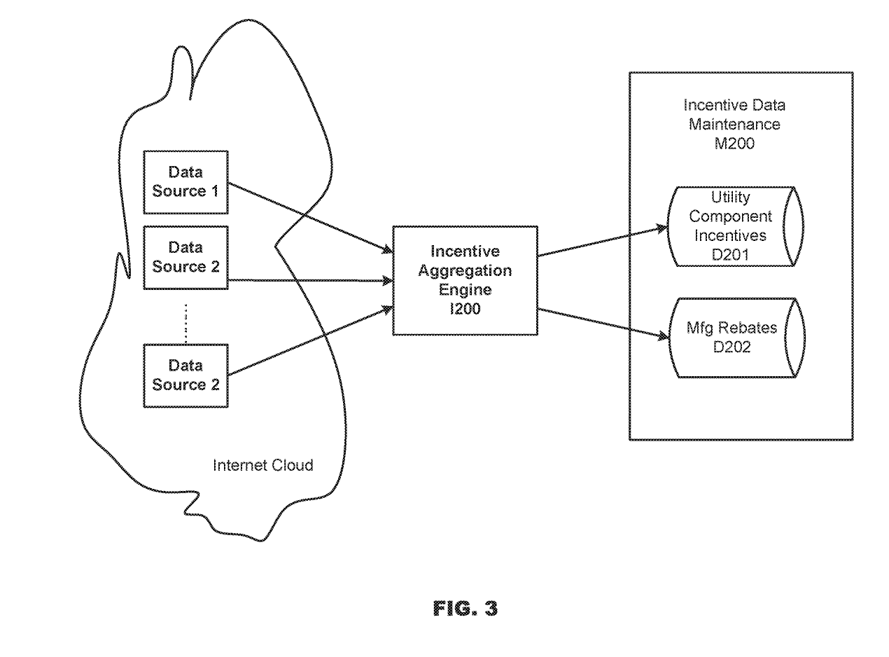

Attention is now directed to FIG. 3, which provides a high-level representation of the operation of the Incentive Aggregation Engine I200.

Incentive Aggregation Engine I200 monitors a host of known websites and less known disparate databases or other data sources (labeled data source 1, data source 2 through data source N in FIG. 3) to collect the most recent online government tax credits and incentives and manufacturer rebates collectively referred to as “Incentives”. The Incentive information collected is aggregated and loaded into Incentives Entity E200 (see FIG. 1) with physical tables residing in RA_DB01 on the internet based RA_Server. Some manual interaction may be involved to keep certain rebate and incentive information up to date that is not electronically published using Incentive Maintenance Engine M200. This is performed by performing content searches on the internet using search engines such as Google and Bing, identifying promotional incentives that may not be a part of data sources with which Incentive Aggregation Engine 1200 is integrated.

Utility Company Component Incentives Table D201

Referring to FIG. 12C, Utility Company Component Incentive Table D201 lists the D201.dollar_amount or the D201.percent_of_purchase_price for a Component, for Components by zip code for which Utility Company have offered incentives to the homeowners to purchase within the defined D201.date_range.

The Table D201 is used to calculate the net price of a product after all associated rebates and incentives.

Manufacturer Rebates Table D202

Referring to FIG. 12D, Manufacturer Rebates Table D202 identifies the list of products and their manufacturers for which the manufacturers is offering a rebate_amount for a specified date_range in a specified product_region.

Property and Component Load Engine I300

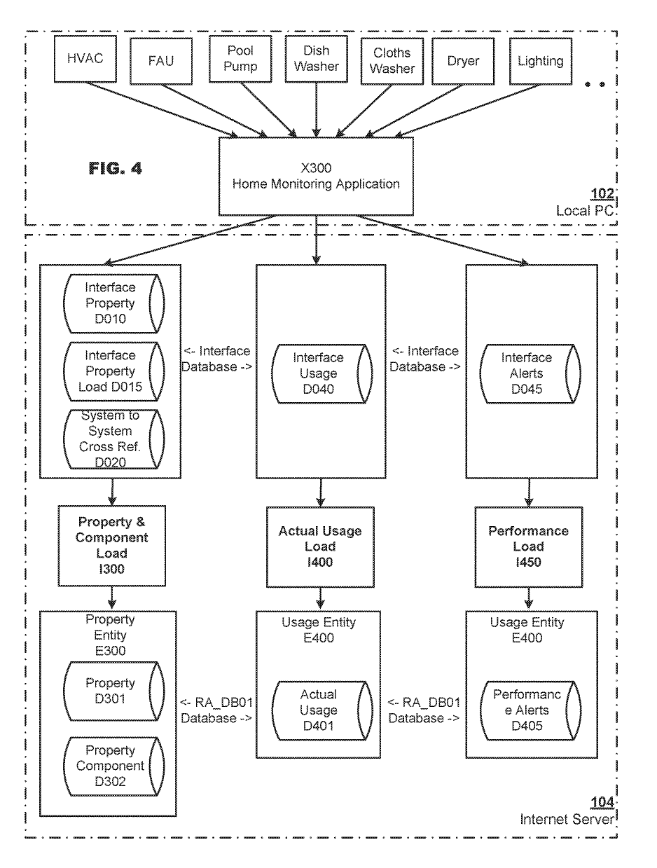

Attention is now directed to FIG. 4, which illustrates the loading of property and component data provided by the home monitoring application X300 into tables maintained by the Internet server 104. In one embodiment the home monitoring application X300 defines property information and property load map information on the local PC 102 located on site at property. The home monitoring application X300 may be implemented using one or more home monitoring applications available from, for example, ECO Dog, Inc.

Referring to FIG. 4, Property Components D302 are the list of components tied to circuits for which the electricity usage is monitored and tracked individually and for the property as a whole. In this embodiment, the system is designed such that X300 is responsible for loading an Interface Property Table D010 and an Interface Property Load Table D015 in the “Interface Database” with required data. A System-to-System Cross Reference Table D020 is maintained to provide common unique identifiers between Property Components and Loads of Interest.

Property and Component Load Engine 1300 gets Property and Component Data from tables in the Interface Database and loads the tables into the logical grouping of tables identified as Property Entity E300 found in the Database of Record RA_DB01.

Referring to FIGS. 12E and 12F, the Property and Component Load Engine I300 periodically, upon setup of a new property, populates Property Table D301 (FIG. 12E) and Property Component Table D302 (FIG. 12F) with property address and Load Map data received from X300 External 3^{rd} Party Energy Monitoring System.

Property and Component Load Engine I300 uses the following tables D010, D015 and D020 as input.

Interface Property Table D010 is shown below:

Interface Property Table D010

| property_ | | | | | | | | |
|---|---|---|---|---|---|---|---|---|
| id | Lname | fname | address1 | City | State | zip | phone1 | email |
| 100 | Smith | John | 1 Main | Cortez | CO | 81321 | 970-564-1000 | js@yahu.com |
| | | | St. | | | | | |

Interface Property Load Table D015 is shown below:

Interface Property Load Table D015

| prop_load_id | propert_id | load_sn | load_type | load_class |
|---|---|---|---|---|
| 1000 | 100 | S123 | HVAC | Heat&Cool |
| 1001 | 100 | S124 | HVAC | Heat&Cool |
| 1002 | 100 | S125 | FAU | Heat&Cool |

System to System Cross Ref Table D020 is shown below:

D020 System to System
Cross Ref Table

| ed_load_type | ra_comp_id |
|---|---|
| ED HVAC | 1 |
| ED FAU | 2 |
| ED Pool Pump | 3 |

Product Aggregation Engine I100 copies records from Interface Property Table D010 directly to Property Table D301, maintaining the unique reference property_id, see FIG. 12E:

Product Aggregation Engine I100 individually copies records from Interface Property Load Table D015 to Property Component Table D302. With each record copied, Product and Component Load Engine I100 loads Table D302.comp_id with D020.ra_comp_id where D020.ed_load_type equals D015.load_type (See FIG. 12F).

Actual Usage Load Engine I400

Again with reference to FIG. 4 and with reference to FIG. 12G, the system is designed such that X300 is responsible for loading Interface Usage Table D040 in the “Interface Database” with required data as shown in FIG. 12G.

Actual Usage Load Engine I400 periodically, on approximately a daily basis in this embodiment, populates a Usage Table D401 with hourly usage data received from X300. Referring to FIG. 12H, a first Usage Table D401 is shown with Example Data depicting actual hourly usage data for a single property component for the month of July, 2010.

Prop_comp_id is determined by cross referencing the D040.load_sn with D302.load_sn.

Performance Alerts Load Engine I450

Again with referenced to FIG. 4, the system is designed such that X300 is responsible for loading an Interface Performance Alert Table D045 in the “Interface Database” with data as follows:

Interface Performance Alerts Table D045

| alert_id | property_id | load_sn | impact_percent | impact_period |
|---|---|---|---|---|
| 1 | 1 | 7 | 25% | ALL |
| . . . | . . . | . . . | . . . | . . . |

Performance Alerts Load Engine I450 loads records from the Interface Performance Alerts Table D045 into Performance Alerts Table D450 in the E400 Usage Entity as follows:

Performance Alerts Table D450

| alert_id | property_id | property_comp_id | impact_percent | impact_period |
|---|---|---|---|---|
| 1 | 1 | 15 | 25% | ALL |
| . . . | . . . | . . . | . . . | . . . |

Prop_comp_id is determined by cross referencing the D045.load_sn with D302.load_sn.

Recommendation Engine

As shown in FIG. 1, the Recommendation Engine 110 retrieves supporting information from Product Entity E100, Incentives & Rebates Entity E200, and Property Entity E300 as well as other proprietary data in the Database of Record RA_DB01.

Turning now to FIG. 5, an exemplary embodiment of the Recommendation Engine 110 runs the Recommendation Method 1000 of FIG. 5 by performing the following processing steps:
At stage 1100, the Recommendation Engine 110 builds a complete set of “possible” alternative Components into Property Alternate Components Table D303 and “possible” alternative products into Property Alternate Products Table D304 for every Existing Product in every home where the Existing Product has an energy efficient equivalent on the market today. The term “possible,” with respect to Alternate Components, is determined by the list of Alternate Efficiencies of Components, as enumerated in the Alternate Efficiency Table D103, which fall into the same Size Bucket, referenced in Table D105, as the product being replaced, referenced to the Property in Table D302 and whose associated Old Product is referenced in D104. The term “possible,” with respect to Alternate Products, is defined by the list of D101 Energy Efficient Products which fall into the same Size Bucket as any of the Alternate Components defined in the Table D103.
At stage 1200, the Recommendation Engine 110 forecasts the usage based on the Actual Usage Table D401. If sufficient actual usage data exists in Table D401, then using a rationalized component dependant Component Profile D150 and its associated detail in Component Profile Detail Table D151, the Recommendation Engine 110 forecasts an entire year of usage for each Property Component. The forecast is loaded back into the Actual Usage Table D401, but with records tagged as forecast to be distinguished from the “Actual” records.
At stage 1300, for every Property Alternate Component, evaluation is performed by the Recommendation Engine 110 on the impact of replacing with it, its associated existing Property Component. The “Usage Data Set” including Actual and Forecasted data for the property is copied into an Alt Component Table D402 and modified based on the relative efficiency of the new component to the old component. An off the shelf Costing Routine, in this embodiment, the costing routine from EcoDog, Inc., is run on the revised Usage Data Set to cost the impact of the Alternate Property Component on the cost of the Property Component detailed usage and the Whole Home detailed usage together for the year. The combination of each Alternative Component and the Whole Home is defined as a “Component Set”. The cost is often based on a complex Utility Rate tiered structure, often involving time of day, so the entire data set must be costed on a time bucket period of no longer than about one hour of usage data for every hour of the year in order to be accurate. The Forecasting Routine is run iteratively on every Component Set resulting from combining every combination of Property Component and Whole Home with an Alternate Component. Relative to conventional methods, this method results in dramatically less computational cycles (up to two orders of magnitude).
At stage 1400, the Recommendation Engine 110 performs the two phases of the Two Phase Method (see FIG. 9), which is described below.

Build Alternative Component and Product sets by property

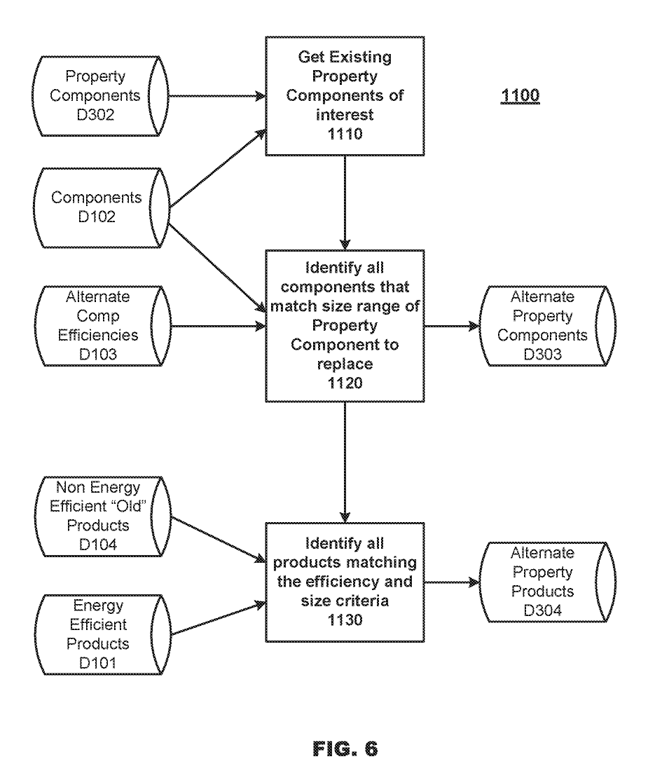

Attention is now directed to FIG. 6, which provides a high-level representation of an exemplary method of building alternative component and product sets by property at stage 1100 of the Method 1000.

The system uses the following Tables as input:
Product Table D101 (FIG. 12B)
Component Table D102 (above)
Efficiency Alternate Table D103 (above)
Old Product Table D104 (FIG. 12A)
Property Component Table D302 (FIG. 12F)

The Recommendation Engine 110 can perform the following algorithm at stage 1100 of the Method 1000 to build the Alternate Components Table D303 from the existing Property Components Table D302:
1. At stage 1110, the Recommendation Engine 110 identifies the records in the Property Component Table D302 where comp_id points to a record in the Component Table D102 and the Table D102 “comp_action” equals “Recommend”. In the example data, this refers to D302 records where “property_comp_id” is in {15,16} in FIG. 12F.
2. At stage 1120, the Recommendation Engine 110, for each Table D302 record identified in Step 1110, performs the following steps:
3. Identify alternate component efficiency records in the Alternate Efficiency Table D103 where Table D302 “size_bucket_id” equals Table D103 “size_bucket_id”. In the example, this refers to D103 records where “alt_eff_id” is in {71,72,73,74,75,76}.
4. For the Table D103 records identified instep 3, load the following information from tables D103 and D302 into the Property Alternative Component Table D303:
   D303.pac_id gets a unique ID
   D303.alt_eff_id”gets D103 “alt_eff_id”
   D303.property_comp_id” gets D302 “property_component_id”

5. For every unique property_id in table D303, load one record which represents the “whole home” as a property_component:
D303.pac_id gets a unique ID
D303.property_comp_id gets 0
D303.alt_eff_id gets 0 (ie no alternate components for “whole home”)

In the example provided, the following data is shown in Table D303:

D303 Property Alternate Component
Table

| pac_id | alt_ef_id | property_comp_id |
|---|---|---|
| 1000 | 0 | 0 |
| 1001 | 71 | 15 |
| 1002 | 72 | 15 |
| 1003 | 73 | 15 |
| 1004 | 74 | 16 |
| 1005 | 75 | 16 |
| 1006 | 76 | 16 |

6. At stage 1130, the Recommendation Engine 110, for each record loaded into Table D303, identifies the records in the Product Table D101 where D101 “alt_eff_id” equals D303 “alt_eff_id”. In the example, this refers to D101 records where “id” is in {1,2,3,4,5,6}.
7. For the Table D101 records identified in Step 6, the Recommendation Engine 110 loads the following information from tables D101 and D303 into the Property Alternate Product Table D304:
   D304 “prop_alt_prod_id” gets a unique ID
   D304 “product_id” gets D101 “product_id”
   D304 “pac_id” gets D303 “pac_id”

In the example provided, the data in the following Property Alternative Product Table D014 is loaded into Table D304:

Property Alternate Product Table D304

| prop_alt_prod_id | product_id | pac_id |
|---|---|---|
| 1 | 101 | 1 |
| 2 | 102 | 2 |
| 3 | 103 | 3 |
| 4 | 104 | 3 |
| 5 | 105 | 4 |
| 6 | 106 | 5 |
| 7 | 107 | 6 |
| 8 | 108 | 6 |

Forecast Costed Usage

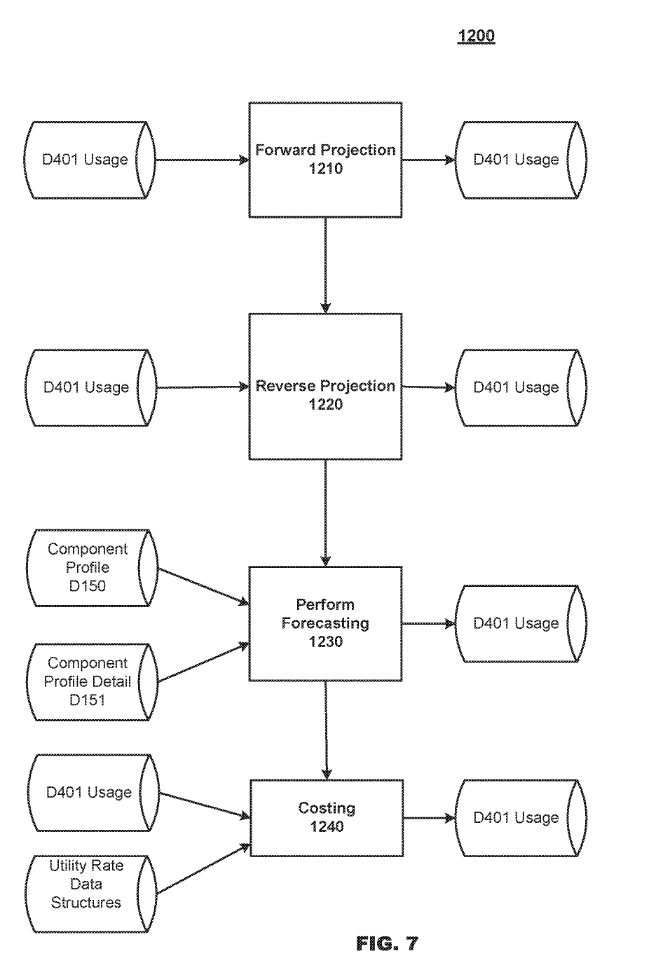

Attention is now directed to FIG. 7, which provides a high-level representation of an exemplary method for forecasting costed usage at the stage 1200 of the Method 1000.

At the stage 1200 of the method 1000, the Recommendation Engine 110 prompts the user to select desired property from a pull down list of property addresses. The selection returns a unique and valid property_id. For the selected property_id, the system forecasts Usage for every record (property component) in the “Property_Component” Table D302 where comp_action=“Recommend”. The system also forecasts the whole home usage in a fictitious property_component_id=0 record. The steps for a single property are defined below.

Assuming an administrator configured minimum amount of “actual” usage data exists, the system builds a usage data set for the entire year using all available actual usage data in Table D401 as input.

D401.hour_id identifies the hour of the current “Forecast_Year”. In the first Table D401 depicted in FIG. 12H, the first row depicts hour_id which means that the usage on that row is the 4345^{th} hour of the year, which equates to the first hour of July 1^{st}.

15 Day Forward Projection at Stage 1210

Under the premise that the best prediction of the average usage for the short term will be the average recent usage, for a given Existing Product at a given Property, i.e. “property_comp id”, the Recommendation Engine 110 will extend a projection for the next 15 days, equal to the average actual usage for the past 30 days as follows:
1. Identify the most recent hourly bucket of actual data available. In the example above, the last hour of actual usage in the table is where id=5088, which is the 24^{th} hour of the 31rst day of July.
2. Extrapolate the subsequent full hour of usage that it must project. In the example, this will be the 1^{st} hour of the 1^{st} day of the next month.
3. For each hourly bucket of a day, the 1^{st} thru the 24^{th}, calculate the average of that bucket for all available days by summing the total “kwh” for every 24^{th} record in the table for as many as exist up to 30 prior days, then divide by the number of days.

In the example, the average will be taken for the bucket associated with the 1^{st} hour of every day for the prior 30 days which will include D401 hour_id's in {5065, 5041, 5017, . . . ,43691}. The average is calculated to be 6.14 kwh.
4. With reference to FIG. 12I, the Recommendation Engine 110 will load 15 new records in Usage Table D401, one record for the 1^{st} hour of every day for the next 15 days. Usage records will be loaded with usage_type=“Projected” to distinguish “Projected” from “Actual”. In the example, a second updated version of Table D401 will now appear as shown in FIG. 121:
5. The Recommendation Engine 110 will repeat the action in step 3 23 times, proceeding with the 2^{nd} hour of the day, and repeating until completing the 24^{th} hour of the day.

15 Day Reverse Projection at Stage 1220

A completely analogous process is performed by the Recommendation Engine 110 to project the 15 days prior to the first bucket of actual usage.

Perform Forecasting at Stage 1230

The forecasting algorithm used by the Recommendation Engine outputs and populates every hourly bucket for the “forecast_year” that is not already populated with “Actual” or “Projected” usage data. The “forecast_year” is defined by a “forecast_year start” and “forecast_year_end.”

In addition to Table D401, as already described, the Forecasting Engine uses the following tables as input:

A Component Profile Table D150 follows:

Component Profile Table D150

| comp_profile_id | name | Description |
|---|---|---|
| 1 | HVAC | Industry Standard data set for prior |
| | Cooling | years that identifies the # of |
| | | degrees of cooing required by hour |
| | | for each day of the year, given a |
| | | target temperature (set in |
| | | D302.target_temp), by location |
| 2 | HVAC | Industry Standard data set for prior |
| | Heating | years that identifies the # of |
| | | degrees of cooing required by hour |
| | | for each day of the year, given a |
| | | target temperature (set in |
| | | D302.target_temp), by location |
| 2 | Lighting | Industry standard start and end |
| | Hours | lighting times by location. |
| 3 | Pool Pump | Proprietary Relative time that Pool |
| | Time | Pumps may be required by |
| | | location. |
| 4 | Temp | Rationalized for use for various |
| | Days | components based on publically |
| | | available historical temperatures |
| | | charts, shows temperature by hour |
| | | by location. Used in calculating |
| | | HVAC Cooling and Heating Days, |
| | | and other components. |

A Component Profile Detail Table D151 follows:

D151 Component Profile Detail

| comp_profile_id | zip | bucket_num | bucket_date | Value |
|---|---|---|---|---|
| 1 | 81321 | 1 | Jan. 1, 2010 | 0 |
| 1 | 81321 | . . . | . . . | . . . |
| 1 | 81321 | 32 | Feb. 1, 2010 | 0 |
| 1 | 81321 | . . . | . . . | . . . |
| 1 | 81321 | 60 | Mar. 1, 2010 | 20 |
| 1 | 81321 | . . . | . . . | . . . |
| 1 | 81321 | 91 | Apr. 1, 2010 | 43 |
| 1 | 81321 | . . . | . . . | . . . |
| 1 | 81321 | 121 | May 1, 2010 | 63 |
| 1 | 81321 | . . . | . . . | . . . |
| 1 | 81321 | 152 | Jun. 1, 2010 | 94 |
| 1 | 81321 | . . . | . . . | . . . |
| 1 | 81321 | 182 | Jul. 1, 2010 | 100 |
| 1 | 81321 | . . . | . . . | . . . |
| 1 | 81321 | 213 | Aug. 1, 2010 | 100 |
| 1 | 81321 | . . . | . . . | . . . |
| 1 | 81321 | 244 | Sep. 1, 2010 | 69 |
| 1 | 81321 | . . . | . . . | . . . |
| 1 | 81321 | 274 | Oct. 1, 2010 | 39 |
| 1 | 81321 | . . . | . . . | . . . |
| 1 | 81321 | 305 | Nov. 1, 2010 | 0 |
| 1 | 81321 | . . . | . . . | . . . |
| 1 | 81321 | 335 | Dec. 1, 2010 | 0 |
| 1 | 81321 | . . . | . . . | . . . |
| 1 | 81321 | 365 | Dec. 31, 2010 | 0 |

For each property_component record for a given property, and whole home the Recommendation Engine 110 performs the following steps at stage 1230:
1. Identify D102 comp_profile_id.
2. For each day where actual data exists and at least 30 days:
3. Calculate the total usage for that day and store it in the first bucket of an variable named day_usage[1].
4. Lookup record in Table D151, where comp_profile_id equals D102 comp_profile_id and bucket_date equals D401 bucket start date. Get D151 “value” and store in the first bucket of an array variable named day_value[1].
5. Divide day_usage[1] by day_value[1]. Store in day_ratio[1].
6. Repeat steps 3 thru 5 for each day with actual usage.
7. Calculate the Average of day_ratio[1]. . . day_ratio[n] and store in “Average_Ratio” Variable.

8. Create a 24 bucket array that stores the average relative hourly use in percentages. Each bucket of the array should have the average actual use for that hour of the array, where the average is taken from the same hour of the day over all days that have actual and projected usage. See example below:
Hour(1): average_use=0%
Hour(2):average_use=0%
Hour(10):average_use=5% of the total for that day
Hour(11):average_use=6% of the total for that day
Hour(12):average_use=8% . . .
Hour(18):average_use=4% . . .
Hour(24):average_use=0%
   Total average_use=100%
9. For all days in the year where no actual or projected data exists:
10. Calculate the total forecasted usage for that day by multiplying the Average_Ratio by day_value(i).
11. Calculate the hourly distribution for that days total by applying the average_use percentages calculated and stored in the Hour[i] array variables.
12. Create hourly forecast records in Table D401 with usage values calculated in prior Steps 9-11
13. Repeat Steps 1 thru 12 for every Property_Component for the selected Property. Additionally performs steps 01 thru 03 for the whole house identified by property_comp_id=0.

Costing at Stage 1240

Costing Routing functionality available from, for example, ECO Dog, Inc. can be used by the Recommendation Engine 110 to update cost field in designates rows in Usage Table D401 as follows:
1. Parameters passed: Table Identified and Component_Set_ID
2. See ERD FIG. 12L Table D402 for ECO Dog Costing Routine( )expected table structure.
3. Costing Routine( )applies applicable Utilility Rate structure incorporating time of use and/or tiered structures specific to the property being analyzed.
4. Update D401 “cost” field with calculated cost associated with the kwh for that record.
5. Complete this process for every hourly bucket in the current forecast year.

With reference to FIG. 12J, output for a single property_component_id resulting from the costing process 1240 is shown in a third version of Usage Table D401 with example data.

After the Forecasting Routine runs for a given property, Usage Table D401 has a record for every hour of the year for a given record in the property_component table for a given property. This is referred to as the “Baseline Usage Set”. In this example, all hourly records for the month of July (hour_id 4345 thru 5088) have usage_type=“Actual.” All hourly records for 15 days before the first record with usage_type32 “Actual” have usage_type=“Projected”, all hourly records for 15 days after the last record with usage_type=“Actual” have usage_type=“Projected”, and the remainder of the hourly records for the year have usage type =“Forecast”.

Build Alternative Usage Data Sets

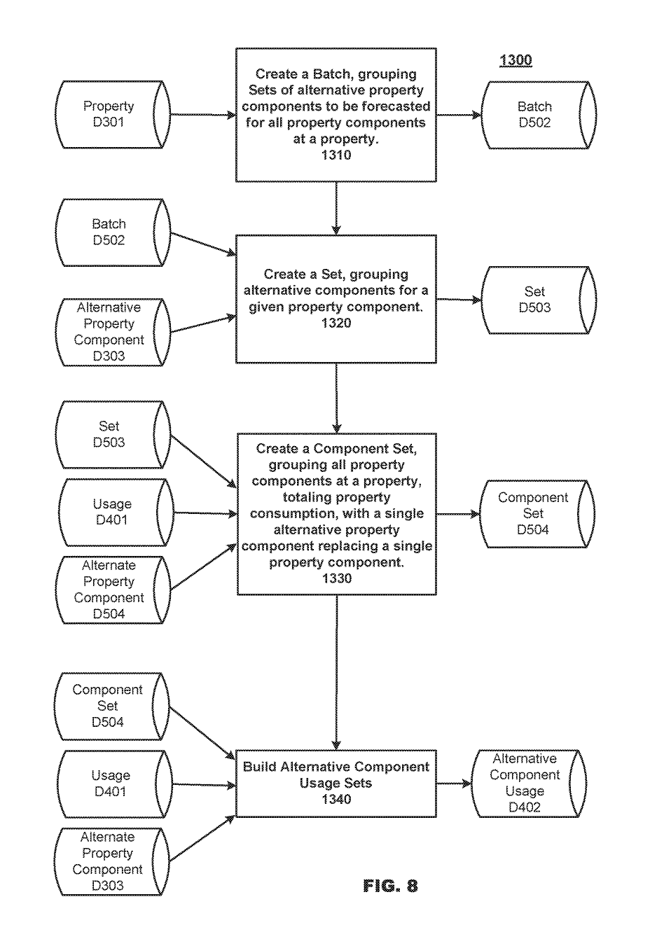

Attention is now directed to FIG. 8, which provides a high-level representation of an exemplary method for building alternative data usage sets at stage 1300 of the method 1000.

The Property Alternate Component Table D303 and Table D401's “Baseline Usage Set” are used as input for the Recommendation Engine 110 to build the Alternate Component Usage Table D402. Recommendation Engine 110 Loads D402 as follows:

Recommendation Engine 110 prompts for user selection of property on which to perform Alternative Component Usage analysis, returning a valid property_id to Recommendation Engine 110.
1. At stage 1310, the Recommendation Engine 110 creates a record in the Batch Table D502 as follows:
2. Property_id returned from user selection.
3. Batch_num is sequenciallly generated.

Batch Table D502

| property_id | batch_num | run_date |
|---|---|---|
| 100 | 1 | 2010-08-01:00:00:00 |

4. At stage 1320, the Recommendation Engine 110 Creates a record in Set Table D503 (shown below) for each unique property_component_id as follows:
5. Property_id , batch_num and carried forward from the loading of table D502
6. Set_num is generated beginning at 1, and incremented for each new record
7. Suff_data_flag:
8. Count the number of records in table D401 where property_comp_id=D303.property.comp_id.
9. If the number of records is greater than or equal to the user specified threshold of “Min_Usage_Records”, then the “suff_data_flag” field is loaded with “YES”, otherwise, it is loaded with “NO”
10. Recommendation Engine 110 loads D503.prop_comp_id with D303.property_comp_id (15 and 16 in this example).

Set Table D503

| property_id | batch_num | set_num | suff_data_flag | prop_comp_id |
|---|---|---|---|---|
| 100 | 1 | 1 | YES | 0 |
| 100 | 1 | 2 | YES | 15 |
| 100 | 1 | 3 | YES | 16 |

11. At stage 1330, the Recommendation Engine 110 loads Component Set Table D504 (shown below) with a record for every record in the Property Alternate Component Table D303 where D303.property_comp_id=D302.property_component_id and D302.property_id=user selected property_id, as follows:
12. Comp_set_id is unique and sequentially generated with each record added to D504.
13. Records are loaded by code equivalent to the following SQL based pseudocode:

```
SELECT
  D503.property_id,
  D503.batch_num,
  D503.set_num,
  D303.pac_id
FROM
  D503,
  D303
WHERE
  D303. property_comp_id = D503.property_comp_id
INTO D504
```

Component Set Table D504

| comp_set_id | property_id | batch_num | set_num | pac_id |
|---|---|---|---|---|
| 1 | 100 | 1 | 1 | 1000 |
| 2 | 100 | 1 | 2 | 1001 |
| 3 | 100 | 1 | 2 | 1002 |
| 4 | 100 | 1 | 2 | 1003 |
| 5 | 100 | 1 | 3 | 1004 |
| 6 | 100 | 1 | 3 | 1005 |
| 7 | 100 | 1 | 3 | 1006 |

14. Remaining at stage 1330, the Recommendation Engine 110 performs steps associated with the following SQL pseudocode:

| CREATE PAC_VIEW “PV1” AS | |
|---|---|
| SELECT | |
| D504.comp_set_id | ‘PV1.comp_set’, |
| D504.property_id | ‘PV1.property.id’, |
| D504.batch_num | ‘PV1.batch_num’, |
| D504.set_num | ‘PV1.set_num’, |
| D303.property_comp_id | ‘PV1.property_comp_id’, |
| D303.alt_eff_id, | ‘PV.alt_eff_id’, |
| D302.ee_value, | ‘PV.old_ee’, |
| D103.ee_value | ‘PV.new_ee’ |
| FROM | |
| D504, D303, D302, D103 | |
| WHERE | |
| D504.property_id = user selected property_id , | |
| AND | |
| D504.pac_id = D303.pac_id, | |
| AND | |
| D303.property_comp_id = D302.property_comp_id, | |
| AND | |

D303.alt_eff_id = D103.alt_eff_id;

15. With reference to FIG. 12K, the Recommendation Engine 110 changes PV1.mod by updating it with a performance modifying percentage for each property_comp_id as dictated by the sum of performance modifiers from the Table D450 Performance Alerts Table (see above), such that mod is set to the current estimated level of excess consumption for each property component. For example Proprety_Comp_Id 15 might be using 25% more energy than its rated specification.
16. At Stage 1340, the Recommendation Engine 110 performs steps associated with the following pseudocode:

```
FOR EVERY RECORD in the PAC View Table PV1 of FIG. 12K:
    Copy D401 records into D402 for property_id = user selected
    property_id
        adding PV1.comp_set_id to the record and keeping all other
    fields the same.
    FOR EVERY RECORD in D402 where D402.comp_set_id =
PV1.comp_set_id:
            IF PV1.old_ee > 0 AND PV1.new_ee > 0
                    THEN {Not whole home record}
                        SET VAR HR_NUM = D402.hour_num
                        SET VAR OLD_KWH = D402.kwh;
                        SET VAR RATIO_VAR =
            PV1.old_ee/PV1.new_ee;
                        D402.kwh GETS OLD_KWH * RATIO_VAR ;
                        SET VAR DIFF_VAR = OLD_KWH -
            D402.kwh;
                        UPDATE TABLE D402
                        D402.kwh GETS (D402.kwh − DIFF_VAR) /
            (1 − Mod%)
                                  (Adjust the estimated usage of
            the new components accounting for both underperformance
            and stated rating of old component. )
                        WHERE
                            D402.compset_id = PV1.comp_set_id,
                              AND
                            D402.property_comp_id = 0,
                              AND
                            D402.hour_num = HR_NUM.;
            END IF;
          SET VAR CURR_COMP_SET = vD402.comp_set_id;
    DONE {For Every Record in D402... }
    Call Third Party ECO Dog, Inc. Costing Routine(TABLE_NAME =
    RA_DB01.D402, COMP_SET_ID = D402.comp_set_id);
    Result of Costing Routine( ) = The records in D402 where
    D402.comp_set_id = CURR_COMP_SET are updated with costs
DONE {For Every Record in PV1... };
```

17. With reference to FIG. 12L, given the large quantity of records resulting from such a query, the example data loaded into Alternate Component Usage Table D402 has been summarized by year, rather than by hour.

Analyze data and heuristics, and generate recommendations using method 1400

Attention is now directed to FIGS. 9-11, which provide a representation of an exemplary Two Phase Method 1400 for generating product recommendations based upon the aggregated product, usage and other collected data which are consistent with user-defined investment priorities or other economic criteria.

At stage 1410 (Phase I)—The Recommendation Engine 110 builds Alternate Component Analysis Table D403 (FIG. 12M) consisting of highly aggregated usage data and all related component and product data.

At stage 1420 (Phase II)—The Recommendation Engine 110 builds highly aggregated usage data sets for Alternate Products into Alternate Product Usage Table D404 (FIG. 12N), based on User Defined Sets of Investment Priorities D505 and D506 (see FIG. 9) and performs necessary calculations.

Phase I

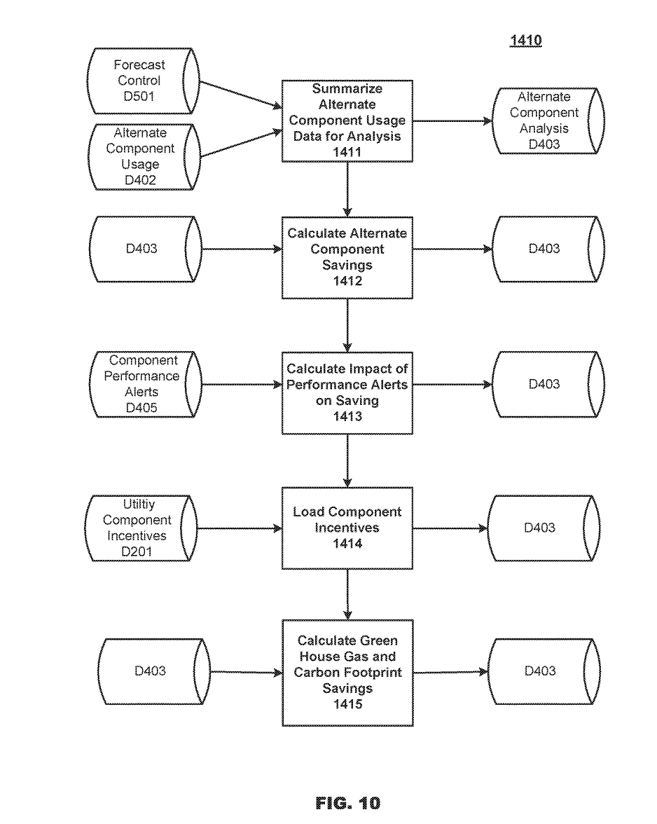

In reference to FIG. 10, at stage 1411, the Recommendation Engine 110 summarizes Alternate Component Usage Data D402 into more aggregated buckets and loads this into Alternate Component Analysis Table D403.

Bucket aggregation is defined as configured in the Forecast Control Table D501. replacement_bucket_size

In one embodiment a “Whole Home Record” identifies data D403 for the Whole Home. In this embodiment there is exactly one Whole Home Record for every Component Set. Whole Home Records are identified as follows:
Pac_id=0,
Property_comp_id=0,
Alt_eff_id=0;

The D403.“Primary Record” identifies D403 data for the Existing Property Component. Exactly one of the many Component Sets that belong to a given Set has a Primary Record. The Component Set which the Primary Record belongs to is defined to be the “Baseline Component Set”. The Baseline Component set has one Primary Record for every unique existing Property Component and one Whole Home Record. The Baseline Component Set identifies data for the existing Property Components and does not identify any Alternate Component data.

The Primary Records are identified as follows:
Pac_id=0,
Property_comp_id>0
Alt_eff_id=0;

The D403.“Alternate Record” identifies data for an Alternate Component as if substituted for the Existing Primary Component. Every Component Set that is the Baseline Component Set, is defined to be an “Alternate Component Set” and will have exactly one Whole Home Record and one Alternate Record. The Alternate Records are identified as follows:
Pac_id >0,
property_comp_id>0
alt_eff_id>0

There are often many Alternate Component Sets in a Set with a single Baseline Component Set, because there are often many potential Alternate Components to replace an existing Property Component (three 15's and thee 16's in this example).

The Usage associated with the Whole Home Record is inclusive of either the Primary Record or the Alternate Record.

At stage 1412, the Recommendation Engine 110 performs saving calculations and updates Table D403. The Recommendation Engine calculates savings associated with Alternate Record and the Whole Home Record in each Alternate Component Set with the following expressions:

```
D403.Alternate_Record.savings_kwh := D403.Primary_Record.kwh −
      D403.Alternate_Record.kwh;
D403.Alternate_Component_Set.Whole_Home_Record.savings_kwh :=
      D403.Alternate_Record.savings_kwh;
D403.Alternate_Record.savings := (D403.Primary_Record.usage_cost * (
      D403.Alternate_Record.savings_kwh / D403.Primary_Record.kwh);
D403.Alternate_Component_Set.Whole_Home_Record. savings :=
      D403.Alternate_Record.savings;
```

Note: The expression “D403.Alternate_Component_Set.Whole_Home Record.savings_kwh” refers to the “savings_kwh” field, in the “Whole_Home_Record” as already defined, in the “Alternate_Component_Set” as already defined, in Table “D403 ” as already defined.

At stage 1413, the Recommendation Engine 110 calculates impact of performance alerts on savings. The Recommendation Engine 110 gets D520.reduce_by_percent from the most recent related Performance Alerts from Performance Alert Table D502, where the D502.Property_Component_id matches D403.property_component_id AND D520.alert_type=“EXCESS_USAGE” and updates appropriate fields in D403.

With the existence of an Alert identifying a Performance Impact to the associated Property Component, the associated Alternate Components usage is revised to eliminate the impact of the Property Component improper performance on the calculation of the Alternate Component Usage and Savings. D403.Whole_Home.perf_kwh and .savings is also updated. These calculations can be performed by the Recommendation Engine 110 applying the following expressions in sequence:

D403.Primary_Record.perf_kwh:=D403.Primary_Record.kwh*(1-D502.reduce_by_percent) 1.

D403.Primary_Record.perf_cost:=D403.Primary_Record.usage cost*(D403.Primary_Record.perf_kwh/D403.Primary_Record.kwh) 2.

If no alert is identifying usage impact on a particular D403.property_component_id, then D403.perf_kwh:=D403/Alternate_Record.kwh, for both Primary Record and Alternate Records 3.

Else, For each Alternate Component Set, update the Alternate Record as follows:

D403. Alternate_Record.perf_kwh:=D403. Primary_Record.perf_kwh*(Alternate_Record.kwh/Primary_Record.kwh) 4.

D403. Alternate_Record.perf_cost:=D403. Alternate_Record.usage_cost*(D403. Alertnate_Record.perf_kwh/D403.Alternate_Record.kwh); 5.

D403. Alternate_Record.perf_savings:=D403. Primary_Record.usage_cost−D403. Alternate_Record.perf_cost; 6.

And, Update the Whole Home Record as follows:

D403. Whole_Home_Record.perf_kwh:=D403. Whole_Home_Record.kwh D403. Alternate_Record.kwh+D403.Alternate_Record.perf_kwh. 7.

D403. Whole_Home_Record.perf_cost:=D403. Whole_Home_Record.usage_cost−D403. Alternate_Record.usage_cost +D403. Alternate_Record.perf_cost; 8.

D403. Whole_Home_Record.perf_saving:=D403. Alternate_Record.perf_saving; 9.

At stage 1414, the Recommendation Engine 110 loads Utility Component Incentives into the Component Analysis Table D403 by performing the following steps:
1. Join related tables to gather Utility Company Rebates that may apply to Components of a particular efficiency level, or to specific products:
2. Determine amount of Rebate from Component Rebate Table D201 and store in D403.comp_rebate
3. Determine amount of “Best Case Rebate” from Product Rebate Table D202. “Best Case Rebate” is defined to be the highest rebate of any Product in Product Table D101 where D101.alt_eff_id=D403.alt_eff_id.
4. Store Best Case Rebate in D403.product_rebate.

At stage 1415, the Recommendation Engine 110 calculates carbon footprint savings and green house gas savings by performing the following steps:
5. With reference to FIG. 12M, the Recommendation Engine 110 performs calculations with respect to D403.savings_kwh shown in the eighth column of Alternate Component Analysis Table D403.

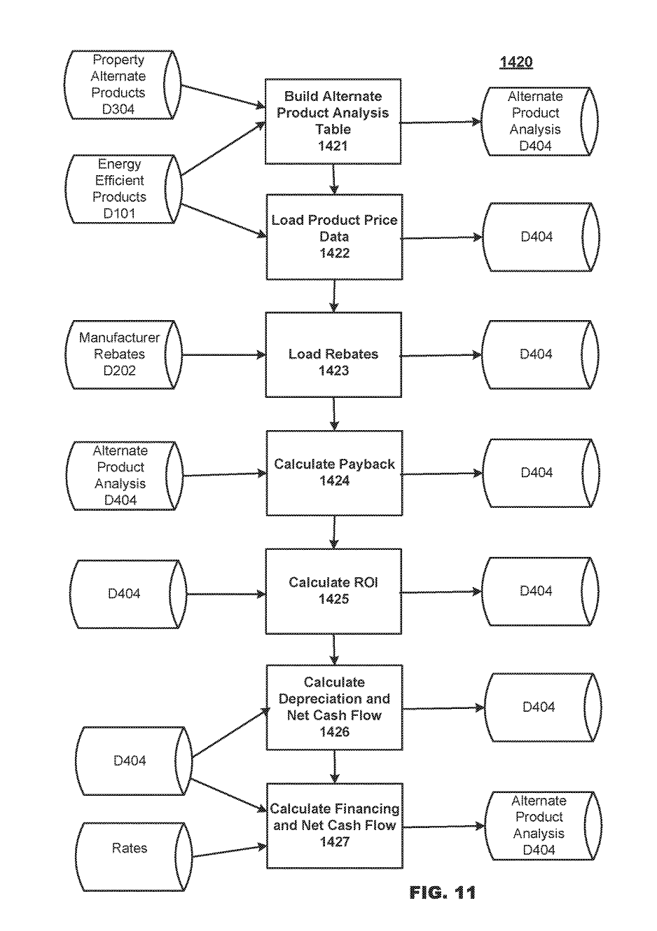

Phase II
1. Table D403 post stage 1410 processing:
2. Referring to FIG. 11, at stage 1421, the Recommendation Engine 110 builds Alternate Product Analysis Table D404 (see FIG. 12N) for all Alternate Products for every Alternate Component.
3. Further at stage 1421, the Recommendation Engine 110 joins the appropriate tables to perform the data load as depicted with the following SQL:

Pseudo code:

```
JOIN
      D403. TO D404 ,
      D403 TO D304 ,
      D304 TO D101
WHERE
      D403.comp_analysis_id = D404.comp_analysis_id,
AND
      D403.pac_id = D304.pac_id,
AND
      D304.product_id = D101.product_id;
```

For every Alternate Record in D403 table, load all records from Property Alternate Products Table D304 WHERE D403. pac_id=D304.pac_id;

At stage 1422, the Recommendation Engine 110 loads the following Product Price Data into Table D404:
D404.product_id:=D304. product_id;
D404.price:=D101.cost_avg;
D404.useful_life:=D101.useful_life;

At stage 1423, the Recommendation Engine 110 loads the following Product Price Data into Table D404:
D404.product_rebate:=D101.mfg_rebate;

At stage 1424, the Recommendation Engine 110 calculates a number of periods for the property owner to recover their investment in the new product using the following expression:

D403.payback_periods:=D403.net_price/D403.perf_savings;

At stage 1425, the Recommendation Engine 110 calculates a Return on Investment with the following expression:

D403.roi:=1/D403.payback_periods

At stage 1426, the Recommendation Engine 110 calculates depreciation and net cash flow. In one aspect, the Recommendation Engine 110 uses a straight line method over the useful life of the product for calculating the deprecation and net cash flow. In this aspect, the periodic depreciation is calculated with the following expression:

D404.depr=D404.net_price/D404.useful_life;

The following expression offsets the depreciation with savings:

D404.depr_cash_flow:=D404.depr-D403.perf_savings;

At stage 1427, the Recommendation Engine 110 calculates financing payments and financing net cash flow. In one aspect, the Recommendation Engine 110 calculates D403.fin_low_payment using a standard amortization schedule calculation with the follow fields as input:
# Payments=D404.useful_life;
Interest Rate=D900.int_rate;
Principal=D404.net_price

FIG. 12N shows an example of a Product Analysis Table D404 including exemplary post 1420 processing.

Web Based User Interface UI100 and Other System Functionality.

Screen shots of graphical user interfaces generated by a server configured consistent with the teachings herein.
1. Provide Component Recommendations to consumers with supporting benefits.
2. Allow consumers to select and engage a contractor that provides the desired service to purchase and install recommendations.
3. Allow consumer to purchase recommended products by connecting them to online retailers.
4. Allow consumers to apply for incentives, credits, and rebates.
5. Allow consumers to select best financing options.
6. Allow consumer to assess impact of the energy efficient products they purchased

In one or more exemplary embodiments, the functions, methods and processes described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

It is understood that the specific order or hierarchy of steps or stages in the processes and methods disclosed are examples of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, processors may be processors, such as communication processors, specifically designed for implementing functionality in communication devices or other mobile or portable devices.

The steps or stages of a method, process or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the disclosure is not intended to be limited to the aspects shown herein but is to be accorded the widest scope consistent with the principles and novel features disclosed herein. It is intended that the following claims and their equivalents define the scope of the disclosure.
Set forth below in ascending order, with status identifiers, is a complete listing of all claims currently under examination. Changes to any amended claims are indicated by strikethrough and underlining. This listing also reflects any cancellation and/or addition of claims.

1-12. (canceled)

13. A system for energy management of a premises, the system comprising:
one or more network interfaces configured to:
receive, from an energy monitoring system in communication with an energy-consuming product in the premises, energy usage information relating to the energy-consuming product, and
receive product data relating to alternate energy-consuming products capable of replacing the energy-consuming product; and
a processor communicatively coupled to the one or more network interfaces and configured to:
determine, based upon at least the energy usage information, an estimated energy usage,
store the product data within a memory,
group the alternate energy-consuming products into a plurality of categories of the alternate energy-consuming products wherein each of the plurality of categories is associated with an energy efficiency;
determine, based upon at least the estimated energy usage, a plurality of costs associated with replacement of the energy-consuming product with a product from each of the plurality of categories wherein each of the plurality of costs includes a component relating to energy usage of products throughout the premises, and
generate, based upon at least the plurality of costs, a recommendation to replace the energy-consuming product with at least one of the alternate energy-consuming products.

14. The system of claim 13 wherein the product data includes purchase incentive information.

15. The system of claim 13 wherein one of the network interfaces is further configured to receive information relating to a user-defined financial objective wherein the generating is further based upon the user-defined financial objective.

16. The system of claim 13 wherein one of the network interfaces is further configured to send a message including the recommendation to a client terminal.

17. A system for energy management of a premises, the system comprising:
one or more network interfaces configured to:
receive, from an energy monitoring system in communication with an energy-consuming product on the premises, energy usage information relating to the energy-consuming product, and
receive product data relating to at least one alternate energy-consuming product capable of replacing the energy-consuming product wherein the product data includes purchase incentive information and wherein the at least one alternate energy-consuming product is included in one of a plurality of categories of alternate energy-consuming products wherein each of the plurality of categories is associated with an energy efficiency; and
a processor communicatively coupled to the one or more network interfaces and configured to:
determine, based upon at least the energy usage information, an estimated energy usage;
store the product data within a memory,
determine, based upon at least the estimated energy usage, a cost associated with replacement of the energy-consuming product with the at least one energy-consuming product wherein the cost includes a component relating to energy usage of products throughout the premises, and
generate, based upon at least the cost and the product data, a recommendation to replace the energy-consuming product with the at least one alternate energy-consuming product.

18. The system of claim 17 wherein the product data further includes data relating to a category of alternate energy-consuming products including the at least one alternate energy-consuming product.

19. The system of claim 17 wherein one of the network interfaces is further configured to receive information relating to a user-defined financial objective wherein the generating is further based upon the user-defined financial objective.

20. The system of claim 17 wherein one of the network interfaces is further configured to send a message including the recommendation to a client terminal.

21. A system for energy management of a premises, the system comprising:
one or more network interfaces configured to:
receive, from an energy monitoring system in communication with an energy-consuming product on the premises, energy usage information relating to an energy-consuming product,
receive alternate product data relating to alternate energy-consuming products, capable of replacing the energy-consuming product, the alternate product data including purchase incentive information; and
receive information relating to a user-defined financial objective; and
a processor communicatively coupled to the one or more network interfaces and configured to:
store the product data within a memory,
group the alternate energy-consuming products into a plurality of categories of the alternate energy-consuming products wherein each of the plurality of categories is associated with an energy efficiency;
determine, based upon at least the energy usage information, a plurality of costs associated with replacement of the energy-consuming product with a product from each of the plurality of categories wherein each of the plurality of costs includes a component relating to energy usage of products throughout the premises, and
generate, based upon the plurality of costs and the user-defined financial objective, a recommendation to replace the energy-consuming product with at least one of the alternate energy-consuming products.

22. The system of claim 21 wherein the processor is further configured to determine, based upon at least the energy usage information, an estimated energy usage wherein the cost information is further based upon the estimated energy usage.

23. The system of claim 21 wherein the product data includes purchase incentive information.

24. The system of claim 21 wherein one of the network interfaces is further configured to send a message including the recommendation to a client terminal.
